(19) United States
(12) Patent Application Publication
(10) Pub. No.: US 2009/0251760 A1
(43) Pub. Date: Oct. 8, 2009

(54) MICRO MIRRORS HAVING IMPROVED HINGES

(75) Inventor: Shaoher X. Pan, San Jose, CA (US)

Correspondence Address: FISH & RICHARDSON P.C., PO BOX 1022, MINNEAPOLIS, MN, 55440-1022, US

(73) Assignee: SPATIAL PHOTONICS, INC., Sunnyvale, CA (US)

(21) Appl. No.: 12/061,182

(22) Filed: Apr. 2, 2008

(51) Int. Cl. G02B 26/08

(52) U.S. Cl. 359/291

(57) ABSTRACT

A micro mirror device includes a hinge supported upon a substrate. The hinge has a length and a width substantially parallel to an upper surface of the substrate, and has a thickness substantially perpendicular to the upper surface of the substrate. The thickness is larger than the width. A mirror plate is tiltable around the hinge. The hinge can produce an elastic restoring force on the mirror plate when the mirror plate tilts away from an un-tilted position.

### BACKGROUND

The present disclosure relates to the fabrication of micro mirrors. A spatial light modulator (SLM) can be built with an array of tiltable mirror plates having reflective surfaces. Each mirror plate can be tilted by electrostatic forces to an “on” position and an “off” position. The electrostatic forces can be generated by electric potential differences between the mirror plate and one or more electrodes underneath the mirror plate. In the “on” position, the micro mirror plate can reflect incident light to form an image pixel in a display image. In the “off” position, the micro mirror plate directs incident light away from the display image.

### SUMMARY

In one general aspect, a micro mirror device is described that includes a hinge supported upon a substrate, the hinge having a length and a width substantially parallel to an upper surface of the substrate and a thickness substantially perpendicular to the upper surface of the substrate, wherein the thickness is larger than the width; and a mirror plate is tiltable around the hinge, wherein the hinge can produce an elastic restoring force on the mirror plate when the mirror plate tilts away from an un-tilted position.

In another general aspect, a micro mirror device is described that includes a hinge supported upon a substrate, the hinge having a length and a width substantially parallel to an upper surface of the substrate and a thickness substantially perpendicular to the upper surface of the substrate, wherein the thickness is larger than the width, and wherein the hinge has a Young's Modulus below 150 GPa; and a mirror plate tiltable around the hinge, wherein the hinge can produce an elastic restoring force on the mirror plate when the mirror plate tilts away from an un-tilted position that is substantially parallel to the upper surface of the substrate.

In another general aspect, a micro mirror device is described that includes a hinge supported upon a substrate, the hinge having a length and a width substantially parallel to an upper surface of the substrate and a thickness substantially perpendicular to the upper surface of the substrate, wherein the thickness is larger than the width, and wherein the hinge has a Young's Modulus below 150 GPa; a mirror plate tiltable around the hinge, wherein the hinge can produce an elastic restoring force on the mirror plate when the mirror plate tilts away from an un-tilted position that is substantially parallel to the upper surface of the substrate; and a controller that can produce an electrostatic force to overcome the elastic restoring force to tilt the mirror plate from the un-tilted position to a tilted position having a tilt angle at or above 3 degrees relative to the un-tilted position.

Implementations of the systems and methods described herein may include one or more of the following features. The hinge thickness can be equal to or larger than two times the width, preferably equal to or larger than five times of the width. The hinge can have a Young's Modulus below 150 GPa., preferably below 100 GPa. The hinge thickness can be in the range from about 150 to 1000 nanometers. The width can be in the range from about 20 to 150 nanometers. The length can be longer than 1 micron. The mirror plate can be substantially parallel to the upper surface of the substrate when in the un-tilted position. The micro mirror device can further include a controller configured to produce an electrostatic force to overcome the elastic restoring force of the hinge to tilt the mirror plate from the un-tilted position to a tilted position. The controller can produce an electrostatic force to precisely counter the elastic restoring force to hold the mirror plate at the tilted position. The hinge can elastically restore the mirror plate to the un-tilted position after the electrostatic force is reduced or removed. The micro mirror device can further include an electrode on the substrate, wherein the controller is configured to apply a voltage to the electrode to produce the electrostatic force. The voltage can be below 10 volts. The tilt angle at the tilted position can be at or above 3 degrees relative to the un-tilted position, preferably at or above 4 degrees. The hinge can include a material selected from the group consisting of Al, TiNi, an AlTi alloy, an AlCu alloy, AlTiNi, and silicon.

Implementations may include one or more of the following advantages. The present invention discloses an improved micro mirror having a mirror plate supported by posts on a substrate. The mirror plate includes elongated hinges connected to the posts and is tiltable by twisting the hinges. In the present invention, the hinges in the micro mirror are improved to produce low torsional elasticity to enable the tilt of the mirror plate while providing high bending elasticity to prevent sagging in the hinges. The sagging of the mirror hinge can cause an inaccurate tilt angle or tilting speed of the mirror plate. The present invention can thus provide more accurate control in the mirror tilt speed and angle than some conventional systems.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIG. 1 is a side view of an exemplified micro mirror.

FIG. 2 is a perspective view of micro mirror of FIG. 1.

FIG. 3 is an exploded view of the micro mirror of FIG. 1.

FIGS. 4A and 4B illustrate reflections of incident light in the “on” direction and the “off” direction respectively by the tilted mirror plate.

FIG. 5 illustrates the reflection of a laser-emitted incident light by a tilted mirror plate.

FIG. 6 illustrates the reflection of a light-emitting-diode-emitted incident light by a tilted mirror plate.

FIG. 7 illustrates an arrangement of an image projection system including micro mirrors.

FIG. 8 illustrates the temporal profiles of the driving voltage pulses and the resulting tilt angles in the mirror plate.

FIG. 9 is a graph illustrating a response curve of the tilt angle of a mirror plate as a function of the driving voltage for contact and non-contact micro mirrors.

FIGS. 10A and 10B are enlarged views of the elongated hinge in the micro mirror of FIG. 2.

### DETAILED DESCRIPTION

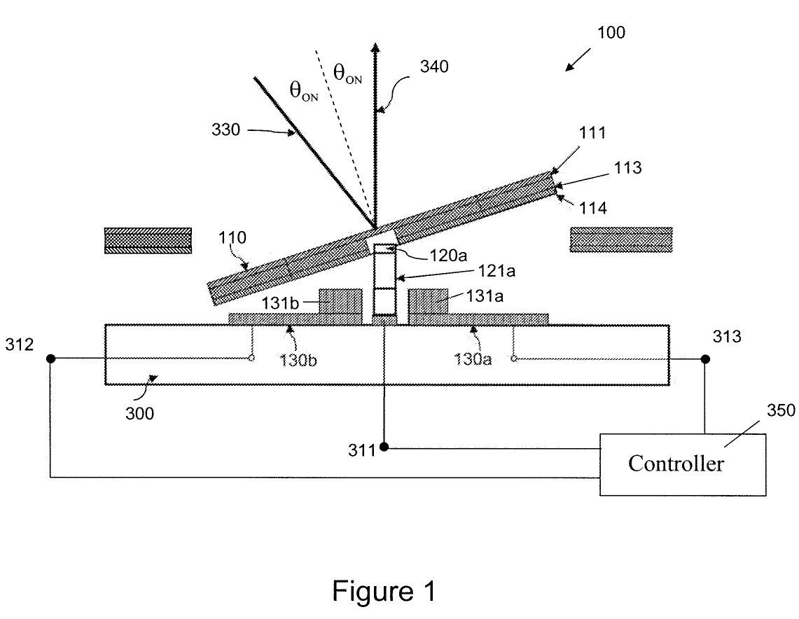

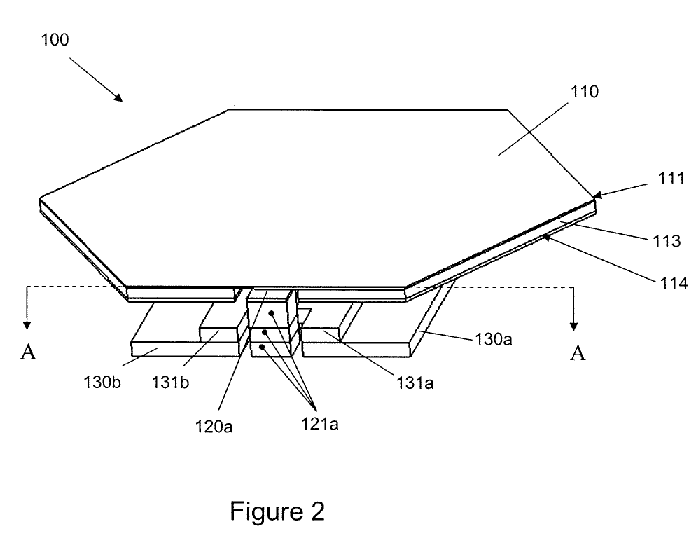

Referring to FIGS. 1-3, a micro mirror 100 includes a mirror plate 110 that includes a reflective layer 111, a spacer layer 113, and a hinge layer 114. In some embodiments, the spacer layer 113 includes a pair of openings 108a and 108b. The hinge layer 114 includes two hinge components 120a and 120b. The hinge components 120a and 120b are connected with the main portion of the hinge layer 114 by elongated hinges 163a and 163b respectively. The elongated hinges 163a and 163b are separated from the main portion of the hinge layer 114 by gaps on the two sides of the elongated hinges 163a or 163b. The mirror plate 110 can be tilted about an axis defined by the two hinge components 120a and 120b. One hinge component 120a (or 120b) is connected to a hinge support post 121a (or 121b) on a substrate 300. The hinge support post 121a or 121b can be formed as a unitary member, or include two or three portions that can be formed in separate deposition steps. The mirror plate 110 is at an un-tilted position when no external force is applied to the mirror plate 110. The un-tilted position can be substantially parallel to the upper surface of a substrate 300.

The micro mirror 100 further includes a two-part electrode with a lower portion 130a and an upper portion 131a on one side of the hinge support posts 121a, 121b, and another two-part electrode with lower portion 130b and upper portion 131b on the other side of the hinge support posts 121a, 121b. The electrode lower portions 130a, 130b can be formed by patterning and etching the same conductive layer. The electrode upper portions 131a, 131b can be formed from another conductive layer over the electrode lower portions 130a, 130b. The hinge support posts 121a, 121b are connected to a control line 311. The two-part electrode 130a, 131a is connected to a control line 313, and the two-part electrode 130b, 131b is connected to a control line 312. The electric potentials of the control lines 311, 312, 313 can be separately controlled by external electric signals provided by a controller 350. The potential difference between the mirror plate 110 and the two-part electrodes 130a, 131a or two-part electrodes 130b, 131b can produce an electrostatic torque that can tilt the mirror plate 110.

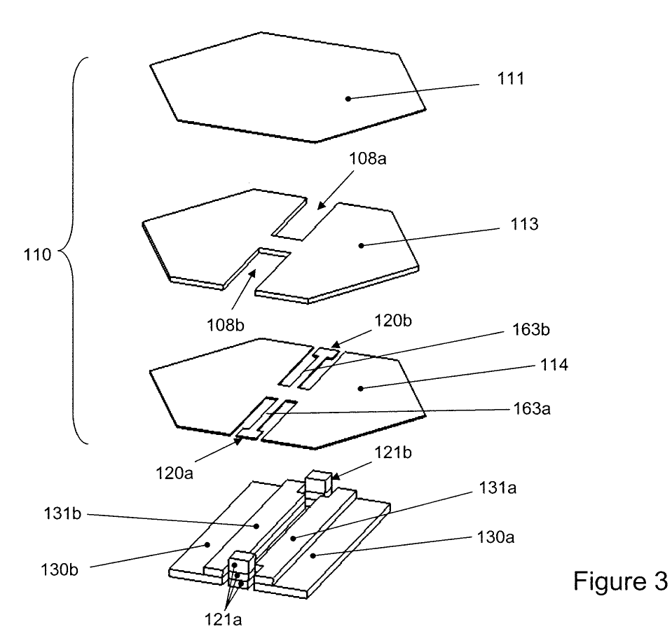

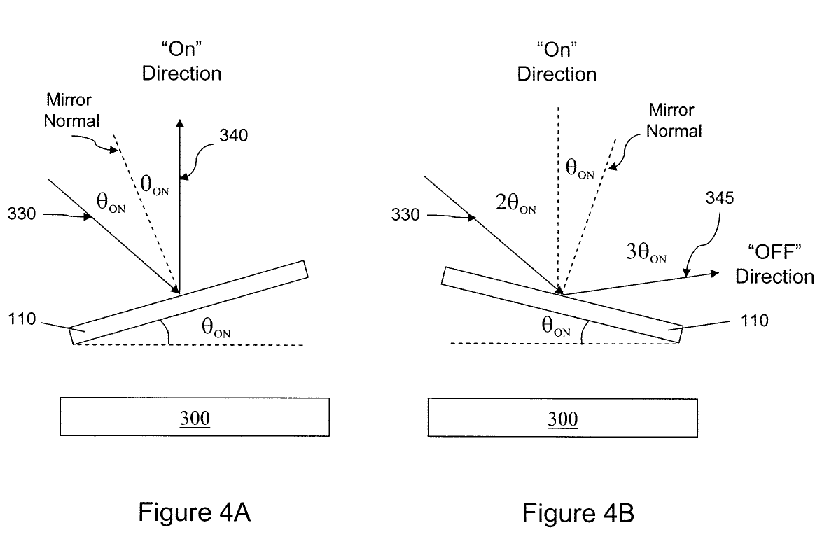

Referring to FIGS. 1 and 4A, the controller 350 can produce an electrostatic force to overcome an elastic restoring force produced by the distorted elongated hinges 163a or 163b (shown in FIG. 3) to tilt the mirror plate from the un-tilted position to a tilted position. The tilted position can be an “on” position or an “off” position. The electrostatic force can counter the elastic restoring force of the hinges to hold the mirror plate at the “on” position or the “off” position. The un-tilted position can be different from the “on” position and the “off” position. In some embodiments, the un-tilted position can also be the same as the “on” or the “off” positions. The mirror plate 110 can tilt in one direction from the un-tilted position to a tilt angle θₒₙ relative to the substrate 300 (the hinge support posts and electrodes are not shown in FIG. 4A for viewing clarity). The mirror plate 110 can reflect an incident light 330 to form reflected light 340 traveling in the “on” direction such that the reflected light 340 can arrive at a display area to form a display image. The “on” direction can be perpendicular to the substrate 300. Because the incident angle (i.e., the angle between the incident light 330 and the mirror normal direction) and the reflection angle (i.e. the angle between the reflected light 340 and the mirror normal direction) are the same, the incident light 330 and the reflected light 340 form an angle 2θₒₙ that is twice as large as the tilt angle θₒₙ of the mirror plate 110.

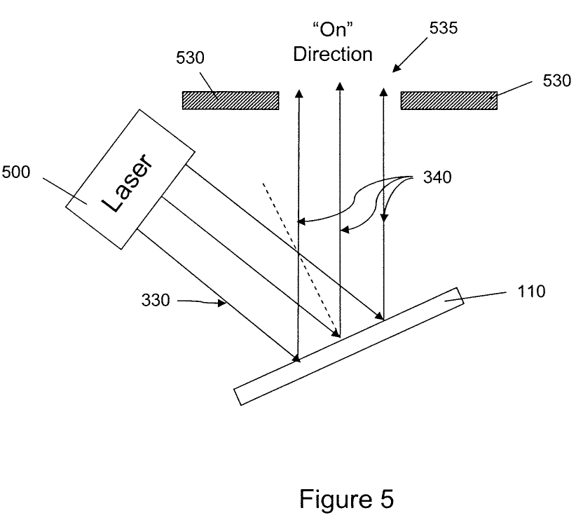

Referring to FIG. 4B, the mirror plate 110 can symmetrically tilt in the opposite direction to an orientation also at a tilt angle θₒₙ relative to the substrate 300 (the hinge support post and electrodes are not shown in FIG. 4B for viewing clarity). The mirror plate 110 can reflect the incident light 330 to form reflected light 345 traveling in the “off” direction. The reflected light 345 can be blocked by an aperture (530 in FIGS. 5-7) and absorbed by a light absorber. Because the incident angle for the incident light 330 is 3θₒₙ, the reflection angle should also be 3θₒₙ. Thus the angle between the reflected lights 340, 345 is 4θₒₙ, four times as large as the tilt angle θₒₙ of the mirror plate 110.

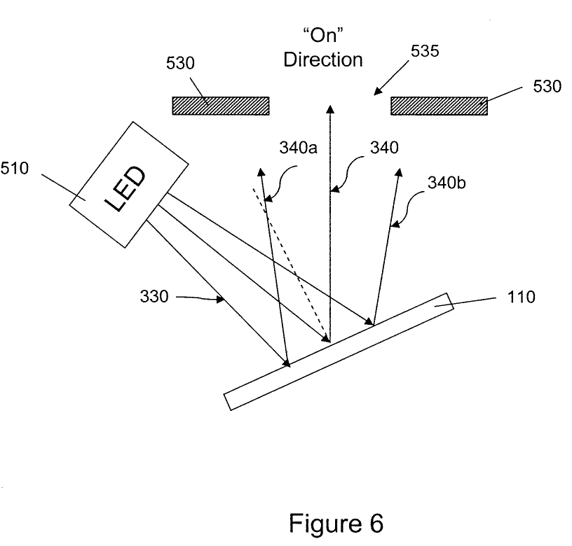

Referring to FIGS. 5 and 6, the incident light 330 can be provided by different light sources, such as a laser 500 or light emitting diode (LED) 510. The incident light emitted by the laser 500 is coherent and can remain collimated after the reflection by the mirror plate 110. An aperture 530, the laser 500, and the mirror plate 110 can be arranged such that almost all the reflected light 340 reflected by the mirror plate 110 when tilted in the “on” direction passes through an opening 535 in the aperture 530. The incident light 330 emitted from the LED 510 is generally non-coherent and tends to diverge over distance, as shown. The aperture 530, the LED 510, and the mirror plate 110 can be arranged such that a majority of the light reflected by the mirror plate 110 at the “on” position passes through the opening 535 in the aperture 530. For example, the reflected light 340 can go through the opening 535, while the reflected light 340a and 340b, which diverges away from reflected light 340, is blocked by the aperture 530.

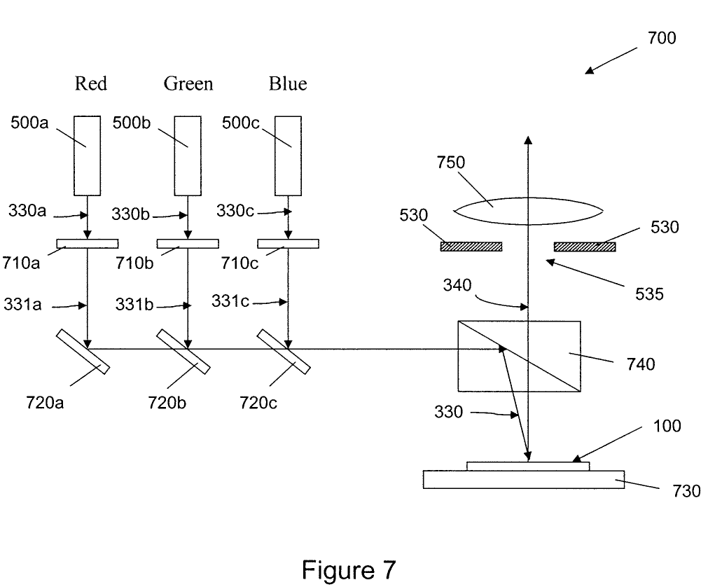

An exemplary image projection system 700 based on an array of micro mirrors 100 is shown in FIG. 7. Red, green, and blue lasers 500a, 500b and 500c can respectively emit red, green, and blue colored laser beams 330a, 330b, and 330c. The red, green, and blue colored light 330a, 330b, and 330c can pass through diffusers 710a, 710b, and 710c, respectively, to form colored light 331a, 331b, and 331c. The diffusers 710a, 710b, and 710c can resize (e.g. expand) and can shape the laser beams 330a, 330b, and 330c to cross-sectional shapes that are compatible with the array of micro mirrors 100. For example, the colored light 331a, 331b, and 331c can be shaped to be rectangular, which can be more compatible with the shape of the array of micro mirrors 100. The colored light 331a, 331b, and 331c can then be reflected by beam splitters 720a, 720b, and 720c (which function as beam combiners), and merged into a color incident light 330. In some embodiments, the color incident light 330 can be reflected by a total internal reflection (TIR) prism 740 to align the direction of the color incident light 330 to illuminate micro mirrors 100 on a support member 730. The reflected light 340 deflected by the mirror plates 110 at the “on” positions can pass through the TIR prism 740 and the opening 535 of the aperture 530, and be projected by a projection system 750 to form a display image.

The relative locations of the aperture 530, the TIR prism 740, and the micro mirror 100 can be arranged such that almost all the reflected light 340 in the “on” direction can pass through the opening 535, and all the reflected light 345 (shown in FIG. 4B) in the “off” direction can be blocked by the aperture 530. Any portion of the reflected light 340 blocked by the aperture 530 is a loss in the display brightness. Any stray reflected light that passes through the opening 535 will decrease the contrast of the display image. The larger the angular spread between the reflected light 340 and the reflected light 345, the easier it is to separate the reflected light 340 and the reflected light 345 to achieve the maximum brightness and contrast in the display image. In other words, the larger the tilt angles θₒₙ (or θ_{off}) in the display system 700, the easier it is to separate the reflected light 340 and the reflected light 345 such that substantially all the reflected light 345 is blocked and substantially all the reflected light 340 arrives at the display surface to form the display image.

In some conventional micro mirror devices, the tilt movement of the mirror plates is stopped by mechanical stops. The “on” and “off” positions of a tiltable mirror plate are defined by the mirror plate's orientation when it is in contact with a mechanical stop. In contrast, referring to FIG. 1, the micro mirror 100 of this invention preferably does not include mechanical stops for defining tilt angles of the mirror plate 110. Rather, the “on” and “off” positions of the mirror plate 110 are controlled by a driving voltage applied to the mirror plate 110 and the two-part electrodes 130a, 131a, and 130b, 131b. For this reason, the disclosed mirror plate 110 can be referred to as a “non-contact” micro mirror. The conventional mirror systems that utilize mechanical stops or include a mirror plate that contacts the substrate when in a tilted position can be referred as “contact” micro mirrors.

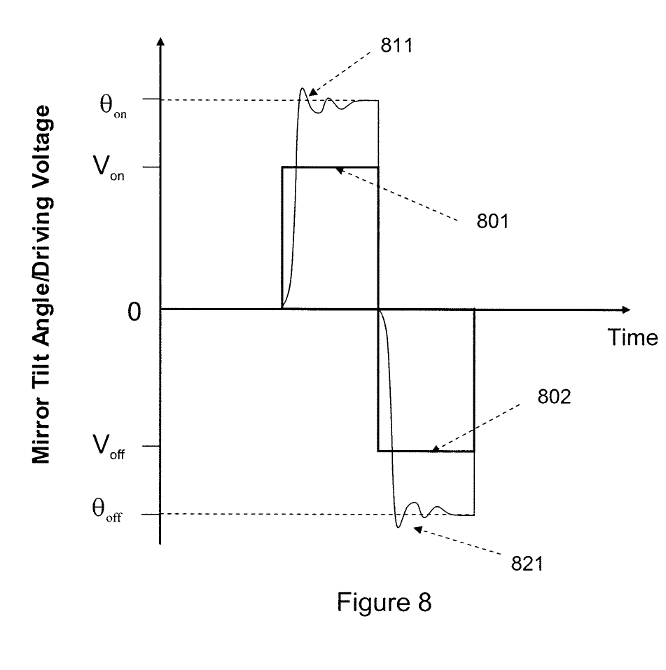

Referring to FIGS. 1 and 8, a positive driving voltage pulse 801 and a negative driving voltage pulse 802 on a graph that shows mirror tilt angle vs. driving voltage. A zero tilt angle corresponds to a non-tilt state (commonly at the horizontal orientation) at which the mirror plate 110 is parallel to the surface of the substrate 300. The mirror plate 110 does not experience any elastic restoring force at the non-tilt state. The positive driving voltage pulse 801 includes a driving voltage Vₒₙ and is used to control the mirror plate 110 to the “on” position, as shown in FIGS. 3, 4A, 5, 6 and 8. The positive voltage pulse 801 can create an electrostatic force that tilts the mirror plate 110 in the “on” direction, which is a counter clockwise direction in the figures, to a tilt angle θₒₙ relative to the upper surface of the substrate 300. As the mirror plate 110 tilts, the mirror plate 110 experiences an elastic restoring force, created by the torsional distortion of the elongated hinges 163a or 163b (shown in FIG. 3), which applies a force on the mirror plate 110 in the clockwise direction. Although the electrostatic force increases somewhat as the tilt angle increases, the elastic restoring force increases more rapidly as a function of the tilt angle than the electrostatic force. The mirror plate 110 eventually stops at the tilt angle θₒₙ when the elastic restoring force becomes equal to the electrostatic force. In other words, the mirror plate 110 is held at the tilt angle θₒₙ by a balance between the electrostatic force and the elastic restoring force that each applies a force on the mirror plate 110 in the opposite direction. The mirror plate 110 may initially oscillate around the average tilt angle θₒₙ in a region 811, and subsequently settle to stay at the tilt angle θₒₙ.

Similarly, a negative driving voltage pulse 802 is used to control the mirror plate 110 to the “off” position, as shown in FIGS. 8 and 4B. The voltage pulse 802 includes a driving voltage V_{off}. The voltage pulse 802 can create an electrostatic force to tilt the mirror plate 110 in the “off” direction, which is a clockwise direction in the figures, to a tilt angle θ_{off} relative to the upper surface of the substrate 300. Again, the mirror plate does not experience any elastic restoring force at the non-tilt position. As the tilt angle increases, the elastic restoring force is created by the torsional distortions of the elongated hinges 163a or 163b (shown in FIG. 3), which applies a force that is in a counter clockwise direction. The elastic restoring force increases more rapidly as a function of the tilt angle than the electrostatic force. The mirror plate 110 eventually stops at the tilt angle θ_{off} when the elastic restoring force becomes equal to the electrostatic force.

The mirror plate 110 is held at the tilt angle θ_{OFF} by a balance between the electrostatic force created by the negative voltage pulse 802 and the elastic restoring force by the distorted elongated hinges 163a and 163b. The mirror plate 110 may initially oscillate around the average tilt angle θ_{off} in a region 821 and then settle to stay at the tilt angle θ_{off}. In the configurations shown in FIGS. 4A and 4B, the tilt angles θₒₙ and θ_{off} have equal magnitude. After the negative driving voltage pulse 802 is removed, the mirror plate 110 can be elastically pulled back to zero tilt angle (i.e. the horizontal orientation) by the elongated hinges 163a and 163b.

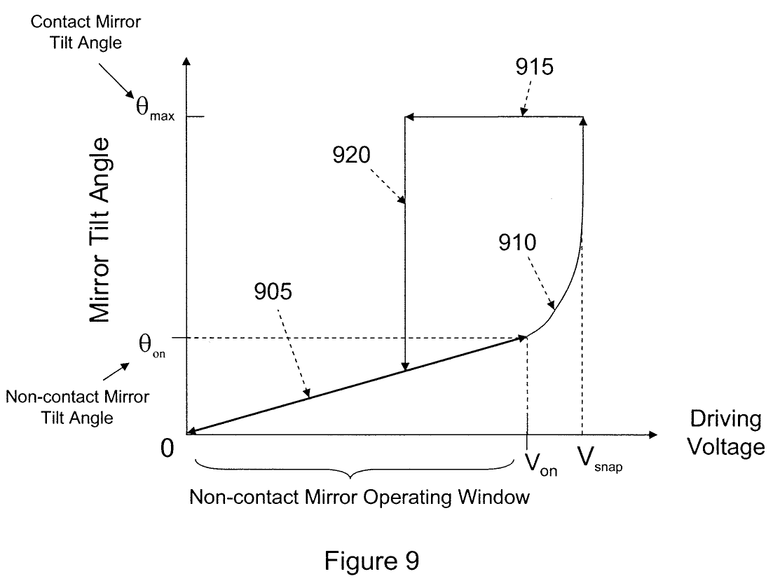

A response curve of the tilt angle of a mirror plate as a function of a driving voltage is shown in FIG. 9. The response curve includes the tilt-angle range for a non-contact micro mirror, and for comparison, the response curve of the tilt-angle range for a contact-type micro mirror. The tilt angle of the mirror plate of a non-contact mirror first gradually increases as a function of the driving voltage along a curve 905. The tilt angle then rapidly increases along a curve 910 as the driving voltage increases until the mirror plate “snaps” at a snapping voltage Vₛₙₐₚ, at which the elastic restoring force stops increasing as the tilt angle increases. The electrostatic force continues to increase as the tilt angle increases. The imbalance between the stronger electrostatic force and the constant plastic restoring force of the hinge sharply increases the tilt angle to θₘₐₓ at which the tilt movement of the mirror plate is stopped by a mechanical stop on the substrate. In the present specification, the term “snap” refers to the unstable state of an imbalanced mirror plate in which a mirror plate rapidly tilts until it is stopped by a fixed object.

After the micro mirror of a non-contact mirror snaps at the tilt angle θₘₐₓ, the mirror plate initially stays in contact with the mechanical stop within the drive voltage range indicated by line 915 even when the driving voltage decreases. After the hinge returns to an elastic region, restores its elasticity, and can overcome stiction at the mechanical stop, the mirror plate finally tilts back along the response curve 905, where the drive voltage intersects line 920. The hysteresis represented by the curves 905, 910 and lines 915, 920 is a common property of non-contact micro mirrors. The operational window for a non-contact micro mirror is along the curve 905 in the elastic region of the mirror plate. The mirror plate can be tilted and held at a tilt angle θₒₙ or θ_{off} by a driving voltage Vₒₙ. The mirror plate can be elastically restored back to the original position by the hinges 163a and 163b along the same the response curve 905 after the electrostatic force is removed. There is no substantial hysteresis associated with the non-contact micro mirror 100 disclosed in the present specification.

Referring to FIGS. 7-9, non-contact micro mirrors preferably have tilt angles such as about 2°, about 3°, about 4°, about 5°, or higher for optimal brightness and contrast in the display images. A large tilt angle is preferred for the separation of the in reflect lights 340 and 345 (respectively shown in FIGS. 4A and 4B) in the “on” and the “off” directions. A large “on” or “off” tilt angle also requires a wide angular range in which the mirror plate can be tilted and then can be elastically restored by the elasticity of the hinge back to the non-tilt position. The hinges 163a and 163b (shown in FIG. 3) thus need be “soft” enough to tilt and elastically restore in a wider angular range.

An example of a hinge material suitable for the “soft” hinges in the micro mirror 100 is an aluminum titanium nitride with a nitrogen composition in the range of about 0 to 15%, preferably about 0 to 10%, with approximately equal compositions for aluminum and titanium. An exemplified composition for the aluminum titanium nitride compound as a hinge material is Al_{48%}Ti_{48%}N_{4%}. Other materials suitable for the hinges 163a and 163b (shown in FIG. 3) include a TiNi alloy, an AlTiN compound, and an AlTi alloy. For TiNi based hinge material, the titanium composition can be between about 30% and 70%, preferably between about 40% and 60%, or, as an example, between about 45% and 55%. For AlTi based hinge material, the titanium composition can be between about 30% and 70%, preferably between about 40% and 60%, as an example, between about 45% and 55%. Hinge material based on aluminum titanium nitride can have a nitrogen composition in the range of between about 0 and 15%, preferably between about 0 and 15%, and approximately equal amounts of aluminum and titanium. Examples of these material compositions include: Ti_{50%}Ni_{50%} for the TiNi alloy, A1_{48%}Ti_{48%}N_{4%} for the AlTiN compound, Al_{50%}Ti_{50%} for the AlTi alloy, and Al_{90%}Cu_{10%} for the AlCu alloy. Other suitable hinge materials include silicon, titanium, gold, silver, nickel, iron, cobalt, copper, aluminum, a compound containing nitrogen, and an oxide.

The above described materials for soft hinges can have low Young's Moduli between 5 GPa and 150 GPa. For example, titanium has a Young's Modulus of approximately 110 GPa. A titanium nitride can have a Young's Modulus in the range of 120-146 GPa. Aluminum has a Young's Modulus of about 70 Gpa.

An advantage of the above described hinges is that they allow tilt angles in a range of such as about 2°, about 3°, about 4°, or about 5° with low driving voltages by the controller 350 (FIG. 1). For example, the amplitude of the driving voltage pulses can be kept below 10 volts, preferably at 5 volts or below using the exemplified hinge materials described above. The low drive voltages can significantly reduce the complexity and cost in the electric circuitry for the micro mirror 100.

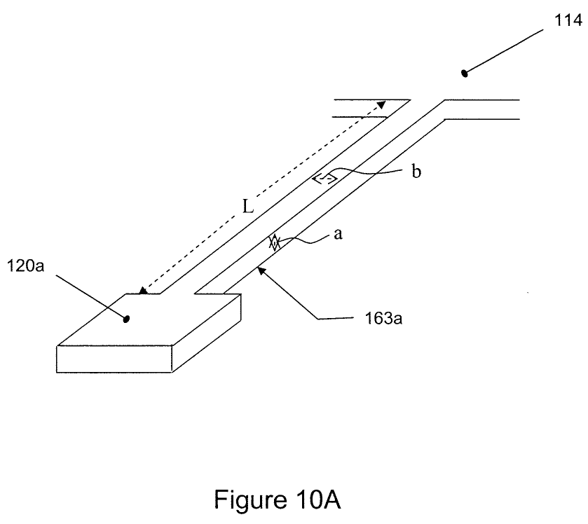

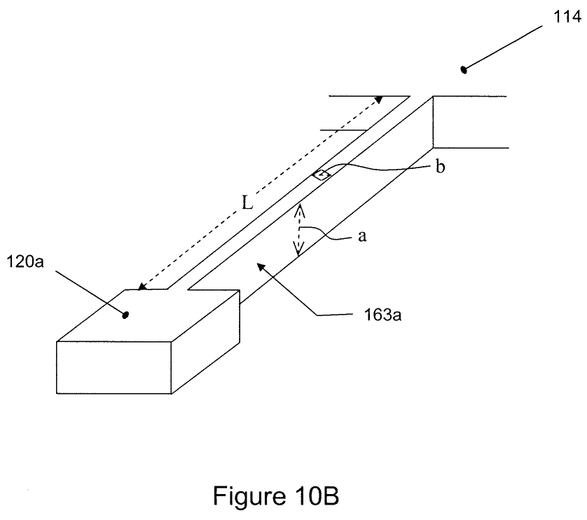

While the above described soft hinges can produce desirably large tilt angles, they can also suffer from a drawback called “hinge sagging.” Referring to FIGS. 3 and 10A, the elongated hinge 163a is defined by a length “L,” a width “b,” and a thickness “a.” In one example shown in FIG. 10A, a hinge has a length “L” of 5 microns, a width “b” of 500 nm, and a thickness “a” of 50 nm. It was observed that when a mirror plate 110 having hinges with these dimensions was positioned in the horizontal direction, the hinges sagged along the long dimension. The weight of the mirror plate 110 is supported by the hinge support posts 121a, 121b through the elongated hinges 163a and 163b. The elongated hinges 163a and 163b sag because they are not rigid enough to support the weight of the mirror plate 110.

In accordance with the present invention, the hinge dimensions can be optimized to overcome the hinge sagging problem while still providing the softness in the torsional elasticity of the elongated hinge. It has been found that the sagging can be reduced or eliminated by increasing the thickness “a.” The soft torsional elasticity can be preserved if the width “b” is concurrently decreased by a proper amount. Specifically, it was observed that the magnitude of hinge sagging is inversely proportional to the bending elasticity, which is proportional to the width “b” and cubic power of the thickness “a” if “a” is smaller than “b.” In other words, the magnitude of hinge sagging is inversely proportional to b×a³, when a<b.

Referring to FIGS. 10A and 10B, the thickness “a” and the width “b” can be referred to as lateral dimensions of an elongated hinge. The torsional elasticity of the elongated hinge 163a is proportional to the cubic power of the narrower lateral dimension and proportional to the wider lateral dimension, that is, proportional to (a³b) if a<b and to (a b³) if b<a. For example, a hinge having L=5 microns, a=500 nm, and b=50 nm has approximately the same torsional elasticity as the hinge described earlier, whose dimensions were L=5 microns, a=50 nm, and b=500 nm. The bending elasticity of the elongated hinge 163a, on the other hand, is increased by a factor of 100 (i.e. by a factor of 50×500³/(500×50³)). This drastic increase in the bending elasticity of the elongated hinge 163a means significantly increased bending rigidity, which can reduce or eliminate hinge sagging of the elongated hinge 163a. In other words, the improved hinge is still “soft” for torsional distortion, which enables the mirror to tilt, but the mirror becomes “stiff” to resist downward bending so it can hold the weight of the mirror plate 110.

Referring to FIGS. 3 and 10A, the hinge thickness “a” is determined by the thickness of the hinge layer 114, which can be controlled by the amount of material deposition in thin film deposition of the hinge layer 114. The hinge width “b” is defined by the mask pattern of the photo mask for etching the gaps besides the hinges 163a and 163b. In some embodiments, it is desirable for hinges 163a or 163b to have their thickness “a” larger than its width “b,” or a>b, to minimize hinge sagging. In some embodiments, it is desirable for the hinges 163a and 163b to have a≧2 b, or a≧5 b, or a≧10 b. The hinge length “L” can be equal to or longer than 1 micron, such as from about 1 to about 10 microns. The Young's Modulus of the hinge material is preferably kept below 150 GPa to lower the rigidity of the hinge. The hinge thickness “a” can be in the range from about 150 to 1000 nanometers. The hinge width “b” can be in a range of from about 20 to 150 nanometers.

It is understood that the disclosed hinges are compatible with other configurations of micro mirrors. The hinges in the micro mirror in the present invention can have different lengths, widths, and thicknesses while preserving the relationship between the width and the thicknesses as described above. Different materials than those described can be used to form the various layers of the mirror plate, the hinge connection posts, the hinge support posts, the electrodes and the mechanical stops. The electrodes can include several sections as shown in the figures, or can be made from a single layer of conductive material. The mirror plate can have different shapes, such as rectangular, hexagonal, diamond, or octagonal. The driving voltage pulses can include different waveforms and polarities. The display system can include different configurations and designs for the optical paths without deviating from the spirit or scope of the present invention. In any instance in which a numerical range is indicated herein, the numerical endpoints can refer to the number indicated or about the number indicated. That is, when a composition has between X and Y % or from X to Y % of a component, it can have between about X and Y %, or in the range of about X to about Y % of the component.

1. A micro mirror device, comprising:
a hinge supported upon a substrate, the hinge having a length and a width substantially parallel to an upper surface of the substrate and a thickness substantially perpendicular to the upper surface of the substrate, wherein the thickness is larger than the width, wherein the hinge comprises a material selected from the gxoup consisting of Al, TiNi, an AlTi alloy, an AlCu alloy, and AlTiNi; and
a mirror plate tiltable around the hinge, wherein the hinge is configured to produce an elastic restoring force on the mirror plate when the mirror plate tilts away from an un-tilted position.

2. The micro mirror device of claim 1, wherein the thickness is equal to or larger than two times of the width.

3. The micro mirror device of claim 2, wherein the thickness is equal to or larger than five times of the width.

4. The micro mirror device of claim 1, wherein the hinge has a Young's Modulus below 150 GPa.

5. The micro mirror device of claim 4, wherein the hinge has a Young's Modulus below 100 GPa.

6. The micro mirror device of claim 1, wherein the thickness is in the range from about 150 to 1000 nanometers.

7. The micro mirror device of claim 1, wherein the width is in the range from about 20 to 150 nanometers.

8. The micro mirror device of claim 1, wherein the length is longer than 1 micron.

9. The micro mirror device of claim 1, wherein the mirror plate is substantially parallel to the upper surface of the substrate when in the un-tilted position.

10. The micro mirror device of claim 1, further comprising a controller configured to produce an electrostatic force to overcome the elastic restoring force of the hinge to tilt the mirror plate from the un-tilted position to a tilted position.

11. The micro mirror device of claim 10, wherein the controller is configured to produce an electrostatic force to precisely counter the elastic restoring force to hold the mirror plate at the tilted position.

12. The micro mirror device of claim 11, wherein the hinge is configured to elastically restore the mirror plate to the un-tilted position after the electrostatic force is reduced or removed.

13. The micro mirror device of claim 10, further comprising an electrode on the substrate, wherein the controller is configured to apply a voltage to the electrode to produce the electrostatic force.

14. The micro mirror device of claim 13, wherein the voltage is below 10 volts.

15. The micro mirror device of claim 1, wherein the tilt angle at the tilted position is at or above 3 degrees relative to the un-tilted position.

16. The micro mirror device of claim 14, wherein the tilt angle at the tilted position is at or above 4 degrees relative to the un-tilted position.

17. (canceled)

18. A micro mirror device, comprising:
a hinge supported upon a substrate, the hinge having a length and a width substantially parallel to an upper surface of the substrate and a thickness substantially perpendicular to the upper surface of the substrate, wherein the thickness is larger than the width, and wherein the hinge has a Young's Modulus below 150 GPa and comprises a material selected from the group consisting of Al, TiNi, an AlTi alloy, an AlCu alloy and AlTiNi; and
a mirror plate tiltable around the hinge, wherein the hinge is configured to produce an elastic restoring force on the mirror plate when the mirror plate tilts away from an un-tilted position that is substantially parallel to the upper surface of the substrate.

19. The micro mirror device of claim 18, wherein the tilt angle at the tilted position is at or above 3 degrees relative to the un-tilted position.

20. The micro mirror device of claim 18, wherein the thickness of the hinge is in the range from about 150 to 1000 nanometers, wherein the width of the hinge is in the range from about 20 to 150 nanometers, and wherein the length of the hinge is longer than 1 micron.

21. The micro mirror device of claim 18, further comprising a controller configured to produce an electrostatic force to overcome the elastic restoring force of the hinge to tilt the mirror plate from the un-tilted position to a tilted position.

22. (canceled)

23. A micro mirror device, comprising:
a hinge supported upon a substrate, the hinge having a length and a width substantially parallel to an upper surface of the substrate and a thickness substantially perpendicular to the upper surface of the substrate, wherein the thickness is larger than the width, and wherein the hinge has a Young's Modulus below 150 GPa, wherein the hinge comprises a material selected from the group consisting of Al, TiNi, an AlTi alloy, an AlCu alloy and AlTiNi;
a mirror plate tiltable around the hinge, wherein the hinge is configured to produce an elastic restoring force on the mirror plate when the mirror plate tilts away from an un-tilted position that is substantially parallel to the upper surface of the substrate; and
a controller configured to produce an electrostatic force to overcome the elastic restoring force to tilt the mirror plate from the un-tilted position to a tilted position having a tilt angle at or above 3 degrees relative to the un-tilted position.

24. The micro mirror device of claim 23, wherein the hinge thickness is in the range from about 150 to 1000 nanometers, wherein the hinge width is in the range from about 20 to 150 nanometers, and wherein the hinge length is longer than 1 micron.

25. (canceled)

26. The micro mirror device of claim 1, wherein the hinge is co-planar with a lower layer of the mirror plate.
